(19) United States
(12) Patent Application Publication
(10) Pub. No.: US 2023/0303857 A1
(43) Pub. Date: Sep. 28, 2023

(54) BLOCK-COPOLYMERS IN ELASTOMERIC ROOF COATINGS

(71) Applicant: BASF SE, Ludwigshafen am Rhein (DE)

(72) Inventor: Kostas S. AVRAMIDIS, Charlotte, NC (US)

(21) Appl. No.: 18/125,168

(22) Filed: Mar. 23, 2023

Related U.S. Application Data
(60) Provisional application No. 63/323,676, filed on Mar. 25, 2022.

(51) Int. Cl. C09D 5/02; C09D 7/65; C09D 133/06; E04D 7/00

(52) U.S. Cl. CPC C09D 5/022; C09D 7/65; C09D 133/064; E04D 7/00

(57) ABSTRACT

Disclosed herein are elastomeric roof coatings containing a block-copolymer, for example for use as a dispersant. In some embodiments, the roof coating compositions can comprise an all-acrylic or styrene-acrylic latex comprising a block-copolymer used in the latex polymerization. The block-copolymers have a molecular weight exceeding 5000 g/mol wherein the block copolymer has a first block comprising of alkyl acrylate and a second block comprising units of an ethylenically unsaturated monomer with sulfonic acid groups.

The modified elastomeric roof coating compositions are advantageous for reasons of water resistance, wet adhesion, tensile strength, and elongation. Methods of making and using the elastomeric roof coating compositions are also disclosed.

### FIELD OF THE DISCLOSURE

This disclosure relates generally to elastomeric roof coatings, and more particularly to elastomeric roof coatings that include a block-copolymer (BCP) dispersant, and to methods of making and using the polymer-modified coating compositions.

### BACKGROUND OF THE DISCLOSURE

The present invention relates to elastomeric roof coating compositions, specifically elastomeric roof coating compositions comprising a block-copolymer dispersant. In recent years, the popularity of elastomeric roof coatings, which are less expensive than their predecessor elastomeric rubber roofing membranes has increased substantially. Desirable properties for coating compositions suitable for use in roofing applications include high tensile strength, high elongation, high flexibility, adhesion, and water resistance. At the present time, roof coatings that meet these performance properties are typically based on polyurethane, silicone, or polyvinyl chloride (PVC) polymers or copolymers. However, roofing systems based on these coatings are prone to failure which is often due to the inability of roof coatings to prevent water infiltration into the elastomeric roofing membrane or the interface with the insulating material. In addition to water resistance, adhesion of the elastomeric coating to the insulating material in the roofing system, especially under wet conditions, i.e., wet adhesion, as well as tensile strength and elongation are of paramount importance. Improvement of these characteristics is important for the durability and mechanical integrity of the roofing system. Thus, there is a need in the art to provide coating compositions that improve the water resistance and service life of roofing systems. The compositions and methods described herein address these and other needs.

### SUMMARY OF THE DISCLOSURE

Disclosed herein are elastomeric roof coating compositions. In some embodiments, the roof coating compositions comprise a latex polymer made using both a first stage and a second stage polymerization, whereby the second stage polymerization is carried out sequentially after the completion or substantial completion of the first stage polymerization in the same reactor. In some embodiments, the coating compositions can include a latex polymer made using only a first or single-stage emulsion polymerization and is derived from one or more monomers including one or more (meth)acrylates, one or more acid monomers, and optionally styrene. The coating compositions can also include a latex polymer made with both a first- and second-stage polymerization whereby the second stage polymer is produced sequentially or substantially sequentially to the first-stage polymerization and is derived from one or more monomers including one or more (meth)acrylates, one or more acid monomers, and optionally styrene. The coating compositions can further comprise a block-copolymer dispersant. This block-copolymer dispersant can replace all the conventional surfactants used in the emulsion polymerization or it can be used as a co-surfactant together with conventional surfactants. The block-copolymers have a molecular weight of over 5000 g/mol with a polybutyl acrylate hydrophobic block and a sodium polystyrene sulfonate hydrophilic block. Methods of making and using the roofing compositions are also disclosed.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure.

FIG. 1 provides a comparison of the dry and wet peel adhesion to 2020 polyurethane foam for elastomeric coatings with and without block-copolymer in the latex polymerization. The elastomeric coatings formulated with the latex of the invention have higher dry and wet adhesion than the elastomeric coating formulated with the latex not comprising the block-copolymer

FIG. 2 provides a comparison of the water absorption, tensile stress, and elongation for elastomeric coatings with and without block-copolymer in the latex polymerization. The elastomeric coatings formulated with the latex of the invention have higher tensile strength, higher elongation and better (lower) 7-day water absorption than the elastomeric coating formulated with the latex not comprising the block-copolymer

FIG. 3 provides a comparison of tensile stress before and after 1000 hours of artificial weathering for elastomeric coatings with block-copolymer in the latex polymerization. The elastomeric coatings formulated with the latex of the invention have similar or higher tensile strength after exposure to 1000 hours of artificial weathering than the corresponding unexposed elastomeric coatings

FIG. 4 provides a comparison of elongation before and after 1000 hours artificial weathering for elastomeric coatings with block-copolymer in the latex polymerization. The elastomeric coatings formulated with the latex of the invention have higher than 100% elongation after exposure to 1000 hours of artificial weathering.

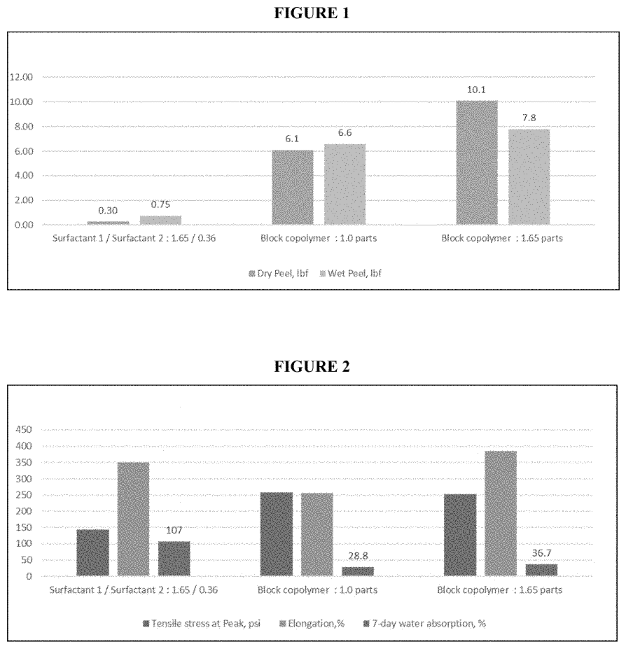

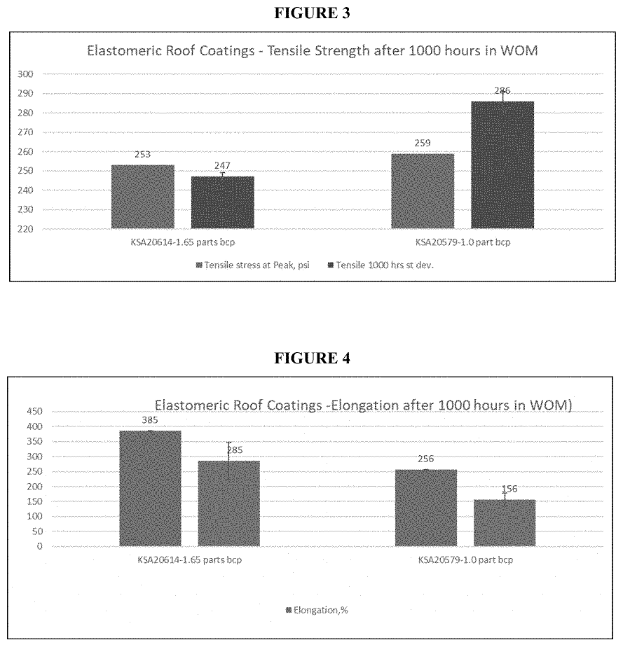

### DETAILED DESCRIPTION

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise. The disclosure of percentage ranges and other ranges herein includes the disclosure of the endpoints of the range and any integers provided in the range.

Disclosed herein are coating compositions and methods for their preparation. The latex polymers used in the coating compositions include a first stage polymer and a second stage polymer in the same particle or substantially in the same particle or the latex polymers used in the coating compositions include a latex comprising particles made from the first stage polymerization and latex particles made by the second stage polymerization or the latex polymers used in the coating compositions include a blend of two or more latex polymers made separately and then blended. The first stage described herein can be derived from one or more monomers including one or more (meth)acrylates, one or more acid monomers, and optionally styrene and acrylonitrile. The second stage described herein can be derived from one or more monomers including one or more (meth)acrylates, one or more acid monomers, and optionally styrene and acrylonitrile.

The one or more (meth)acrylates can include esters of α,β-monoethylenically unsaturated mono- and dicarboxylic acids having 3 to 6 carbon atoms with alkanols having 1 to 12 carbon atoms (e.g., esters of acrylic acid, methacrylic acid, maleic acid, fumaric acid, or itaconic acid, with C1-C12, C1-C8, or C1-C4 alkanols). In some examples, the one or more (meth)acrylates for preparing the first stage and/or second stage are selected from butyl acrylate, 2-ethylhexyl acrylate, methyl methacrylate, and mixtures of these.

The one or more acid monomers can include α,β-monoethylenically unsaturated mono- and dicarboxylic acids (e.g., acrylic acid, methacrylic acid, itaconic acid, maleic acid, fumaric acid, crotonic acid, dimethacrylic acid, ethylacrylic acid, allylacetic acid, vinylacetic acid, mesaconic acid, methylenemalonic acid, or citraconic acid). In some examples, the one or more acid monomers for preparing the first stage and/or second stage are selected from the group consisting acrylic acid, methacrylic acid, itaconic acid, maleic acid, fumaric acid, and mixtures of these.

Optionally, the first stage and the second stage are each derived from at least one low glass transition temperature (Tg) monomer. As used herein, a low Tg monomer refers to a monomer having a Tg value of less than −40° C. for the corresponding homopolymer. Examples of suitable low Tg monomers include butyl acrylate (Tg value of −43° C.) and 2-ethylhexyl acrylate (Tg value of −58° C.).

Optionally, the first stage and the second stage are each derived from at least one high Tg monomer. As used herein, a high Tg monomer refers to a monomer having a Tg value of greater than 40° C. for the corresponding homopolymer. Examples of suitable high Tg monomers include methyl methacrylate (Tg value of 105° C.) and styrene (Tg value of 100° C.).

In some embodiments, at least one of the first stage and the second stage is further derived from an acrylamide or an alkyl-substituted acrylamide. Suitable examples include N-tert-butylacrylamide and N-methyl(meth)acrylamide. In some embodiments, at least one of the first stage and the second stage is further derived from (meth)acrylamide.

Optionally, at least one of the first stage and the second stage is derived from a crosslinkable monomer. For example, the crosslinkable monomer can include diacetone acrylamide (DAAM) or a self-crosslinking monomer such as a monomer comprising 1,3-diketo groups (e.g., acetoacetoxyethyl(meth)acrylate) or a silane crosslinker. Examples of suitable silane crosslinkers include 3-methacryloxypropyl trimethoxysilane, 3-mercaptopropyl trimethoxysilane, vinyl-triethoxysilane, and polyvinyl-siloxane oligomers such as DYNASYLAN 6490, a polyvinyl siloxane oligomer derived from vinyltrimethoxysilane, and DYNASYLAN 6498, a polyvinyl siloxane oligomer derived from vinyltriethoxysilane, both commercially available from Evonik Degussa GmbH (Essen, Germany).

Additional examples of crosslinkable monomers include N-alkylolamides of α,β-monoethylenically unsaturated carboxylic acids having 3 to 10 carbon atoms and esters thereof with alcohols having 1 to 4 carbon atoms (e.g., N-methylolacrylamide and N-methylolmethacrylamide); glyoxal based crosslinkers; monomers containing two vinyl radicals; monomers containing two vinylidene radicals; and monomers containing two alkenyl radicals. Exemplary crosslinkable monomers include diesters or triesters of dihydric and trihydric alcohols with α,β-monoethylenically unsaturated monocarboxylic acids (e.g., di(meth)acrylates, tri(meth)acrylates), of which in turn acrylic acid and methacrylic acid can be employed. Examples of such monomers containing two non-conjugated ethylenically unsaturated double bonds are alkylene glycol diacrylates and dimethacrylates, such as ethylene glycol diacrylate, 1,3-butylene glycol diacrylate, 1,4-butylene glycol diacrylate and propylene glycol diacrylate, vinyl methacrylate, vinyl acrylate, allyl methacrylate, allyl acrylate, diallyl maleate, diallyl fumarate and methylenebisacrylamide. In some examples, the first stage and/or the second stage can include from 0 to 5% by weight of one or more crosslinkable monomers.

The first stage and/or second stage can further include additional monomers. Further examples of additional monomers include vinylaromatics such as α- and p-methylstyrene, α-butylstyrene, 4-n-butylstyrene, 4-n-decylstyrene, and vinyltoluene; conjugated dienes (e.g., isoprene); anhydrides of α,β-monoethylenically unsaturated mono- and dicarboxylic acids (e.g., maleic anhydride, itaconic anhydride, and methylmalonic anhydride); (meth)acrylonitrile; vinyl and vinylidene halides (e.g., vinyl chloride and vinylidene chloride); vinyl esters of C₁-C₁₈ mono- or dicarboxylic acids (e.g., vinyl acetate, vinyl propionate, vinyl n-butyrate, vinyl laurate and vinyl stearate); C₁-C₄ hydroxyalkyl esters of C₃-C₆ mono- or dicarboxylic acids, especially of acrylic acid, methacrylic acid or maleic acid, or their derivatives alkoxylated with from 2 to 50 moles of ethylene oxide, propylene oxide, butylene oxide or mixtures thereof, or esters of these acids with C₁-C₁₈ alcohols alkoxylated with from 2 to 50 mol of ethylene oxide, propylene oxide, butylene oxide or mixtures thereof (e.g., hydroxyethyl (meth)acrylate, hydroxypropyl (meth)acrylate, and methylpolyglycol acrylate); and monomers containing glycidyl groups (e.g., glycidyl methacrylate).

Further examples of additional monomers or co-monomers that can be used include linear 1-olefins, branched-chain 1-olefins or cyclic olefins (e.g., ethene, propene, butene, isobutene, pentene, cyclopentene, hexene, and cyclohexene); vinyl and allyl alkyl ethers having 1 to 40 carbon atoms in the alkyl radical, wherein the alkyl radical can possibly carry further substituents such as a hydroxyl group, an amino or dialkylamino group, or one or more alkoxylated groups (e.g., methyl vinyl ether, ethyl vinyl ether, propyl vinyl ether, isobutyl vinyl ether, 2-ethylhexyl vinyl ether, vinyl cyclohexyl ether, vinyl 4-hydroxybutyl ether, decyl vinyl ether, dodecyl vinyl ether, octadecyl vinyl ether, 2-(diethylamino)ethyl vinyl ether, 2-(di-n-butylamino)ethyl vinyl ether, methyldiglycol vinyl ether, and the corresponding allyl ethers); sulfo-functional monomers (e.g., allylsulfonic acid, methallylsulfonic acid, styrenesulfonate, vinylsulfonic acid, allyloxybenzenesulfonic acid, 2-acrylamido-2-methylpropanesulfonic acid, and their corresponding alkali metal or ammonium salts, sulfopropyl acrylate and sulfopropyl methacrylate); phosphorus-containing monomers (e.g., dihydrogen phosphate esters of alcohols in which the alcohol contains a polymerizable vinyl or olefenic group, allyl phosphate, phosphoalkyl(meth)acrylates such as 2-phosphoethyl(meth)acrylate (PEM), 2-phosphopropyl(meth)acrylate, 3-phosphopropyl (meth)acrylate, and phosphobutyl(meth)acrylate, 3-phospho-2-hydroxypropyl(meth)acrylate, mono- or di-phosphates of bis(hydroxymethyl) fumarate or itaconate; phosphates of hydroxyalkyl(meth)acrylate, 2-hydroxyethyl(meth)acrylate, 3-hydroxypropyl(meth)acrylate, ethylene oxide condensates of (meth)acrylates, H₂C═C(CH₃)COO(CH₂CH₂O)ₙP(O)(OH)₂, and analogous propylene and butylene oxide condensates, where n is an amount of 1 to 50, phosphoalkyl crotonates, phosphoalkyl maleates, phosphoalkyl fumarates, phosphodialkyl (meth)acrylates, phosphodialkyl crotonates, vinyl phosphonic acid, allyl phosphonic acid, 2-acrylamido-2methylpropanephosphinic acid, α-phosphonostyrene, 2-methylacrylamido-2-methylpropanephosphinic acid, (hydroxy)phosphinylalkyl(meth)acrylates, (hydroxy)phosphinylmethyl methacrylate, and combinations thereof); alkylaminoalkyl (meth)acrylates or alkylaminoalkyl(meth)acrylamides or quaternization products thereof (e.g., 2-(N,N-dimethylamino)ethyl (meth)acrylate, 3-(N,N-dimethylamino)propyl (meth)acrylate, 2-(N,N,N-trimethylammonium)ethyl (meth)acrylate chloride, 2-dimethylaminoethyl(meth)acrylamide, 3-dimethylaminopropyl(meth)acrylamide, and 3-trimethylammoniumpropyl(meth)acrylamide chloride); allyl esters of C1-C30 monocarboxylic acids; N-vinyl compounds (e.g., N-vinylformamide, N-vinyl-N-methylformamide, N-vinylpyrrolidone, N-vinylimidazole, 1-vinyl-2-methylimidazole, 1-vinyl-2-methylimidazoline, N-vinylcaprolactam, vinylcarbazole, 2-vinylpyridine, and 4-vinylpyridine).

The first stage and the second stage can independently be pure acrylics, styrene acrylics, or vinyl acrylics. In some embodiments, the first stage is a styrene acrylic copolymer (i.e., the first stage is a styrene acrylic copolymer, the second stage is a styrene acrylic copolymer, or both the first stage and the second stage are styrene acrylic copolymers). In other embodiments, at least one of the first stage and the second stage is a pure acrylic (i.e., the first stage is a pure acrylic, the second stage is a pure acrylic, or both the first stage and second stage are pure acrylics).

The first stage and the second stage can be prepared by polymerizing the monomers using free-radical emulsion polymerization. The monomers for the first stage and the second stage can be prepared as aqueous dispersions. The emulsion polymerization temperature is generally from 30° C. to 95° C. or from 75° C. to 90° C. The polymerization medium can include water alone or a mixture of water and water-miscible liquids, such as methanol. In some embodiments, water is used alone. The emulsion polymerization can be carried out either as a batch, semi-batch, or continuous process. Typically, a semi-batch process is used. In some embodiments, a portion of the monomers can be heated to the polymerization temperature and partially polymerized, and the remainder of the polymerization batch can be subsequently fed to the polymerization zone continuously, in steps or with superposition of a concentration gradient.

The free-radical emulsion polymerization can be carried out in the presence of a free-radical polymerization initiator. The free-radical polymerization initiators that can be used in the process are all those which are capable of initiating a free-radical aqueous emulsion polymerization including alkali metal peroxydisulfates and H₂O₂, or azo compounds. Combined systems can also be used comprising at least one organic reducing agent and at least one peroxide and/or hydroperoxide, e.g., tert-butyl hydroperoxide and the sodium metal salt of hydroxymethanesulfinic acid or hydrogen peroxide and ascorbic acid. Combined systems can also be used additionally containing a small amount of a metal compound which is soluble in the polymerization medium and whose metallic component can exist in more than one oxidation state, e.g., ascorbic acid/iron(II) sulfate/hydrogen peroxide, where ascorbic acid can be replaced by the sodium metal salt of hydroxymethanesulfinic acid, sodium sulfite, sodium hydrogen sulfite or sodium metal bisulfite and hydrogen peroxide can be replaced by tert-butyl hydroperoxide or alkali metal peroxydisulfates and/or ammonium peroxydisulfates. In the combined systems, the carbohydrate derived compound can also be used as the reducing component. In general, the amount of free-radical initiator systems employed can be from 0.1 to 2%, based on the total amount of the monomers to be polymerized. In some embodiments, the initiators are ammonium and/or alkali metal peroxydisulfates (e.g., sodium persulfate), alone or as a constituent of combined systems. The manner in which the free-radical initiator system is added to the polymerization reactor during the free-radical aqueous emulsion polymerization is not critical. It can either all be introduced into the polymerization reactor at the beginning, or added continuously or stepwise as it is consumed during the free-radical aqueous emulsion polymerization. In detail, this depends in a manner known to an average person skilled in the art both from the chemical nature of the initiator system and on the polymerization temperature. In some embodiments, some is introduced at the beginning and the remainder is added to the polymerization zone as it is consumed. It is also possible to carry out the free-radical aqueous emulsion polymerization under superatmospheric or reduced pressure.

The first or second stage can each independently be produced by single stage polymerization or multiple stage polymerization. In some embodiments, the first stage and the second stage are each copolymerized separately to produce a first dispersion including a plurality of polymer particles including the first stage and a second dispersion comprising a plurality of polymer particles including the second stage. The first and second dispersions can then be combined to provide a dispersion including the first and second stages. In some embodiments, the first stage and the second stage are provided in the same polymer particle by using multiple stage polymerization such that one of the first stage and second stage can be present as a first stage copolymer (e.g., as a core in a core/shell polymer particle) and one of the first stage and second stage can be present as a second stage copolymer (e.g., as a shell in a core/shell polymer particle).

As described herein, the roofing compositions comprise a latex polymer that includes a block-copolymer. The block-copolymer is used during the emulsion polymerization and can be present in either the first stage, the second stage, or in both. The first and second stages or the block copolymer can be present in the initial charge of the emulsion polymerization. This block-copolymer may be, for example, a block-copolymer containing a hydrophobic block that attaches to particles in the roofing composition and a hydrophilic block that provides stability. The hydrophobic block may, for example, comprise an alkyl acrylate.

Suitable alkyl acrylates are esters of monoethylenically acrylic acid with C₄-C₂₀-alkanols, examples being n-butyl acrylate, 2-butyl acrylate, isobutyl acrylate, tert-butyl acrylate, n-hexyl acrylate, 2-ethylhexyl acrylate, 3-propylheptyl acrylate, decyl acrylate, lauryl acrylate and stearyl acrylate. Preferred is n-butylacrylate.

As additional monomers of the hydrophobic block it is possible to use for example styrene, C1-C4 alkyl substituted styrene, hydroxyalkyl esters of the α,β-unsaturated C₃-C₆ carboxylic acids, for example 2-hydroxyethyl acrylate, 3-hydropxypropyl acrylate, 4-hydroxybutyl acrylate, hydroxyethyl methacrylate, hydroxypropyl methacrylate, polyethylene glycol mono(meth)acrylate where polyethylene glycol vary from 1-22 repeating units or mixtures thereof. If these additional monomers are present, they are present in an amount up to 20 wt. %, preferably up to 10 wt. %, especially up to 5 wt. %.

The hydrophilic block may comprise units of ethylenically unsaturated monomer with sulfonic acid groups.

Suitable ethylenically unsaturated monomers with sulfonic acid groups are preferably vinylsulfonic acid, 4-styrene sulfonic acid, 2-acrylamido-2-methylpropane sulfonic acid, sulfopropyl acrylate and sulfopropyl methacrylate. The ethylenically unsaturated monomer with sulfonic acid groups can be used as monomers in the form of the free acid as well as in their partially or completely neutralized form. Preferably, sodium hydroxide, potash or ammonia is used as a neutralizing agent. Styrene sulfonic acid and its alkali or ammonium salts are preferred. Especially sodium styrene sulfonate is preferred.

As additional monomers of the hydrophilic block it is possible to use the amides and the hydroxy-alkyl esters of the α,β-unsaturated C₃-C₆ carboxylic acids, for example acrylamide, methacrylamide, 2-hydroxyethyl acrylate, 2-hydroxyethyl methacrylate, 2-hydroxypropyl (meth)acrylate or 1,4-butanediol monoacrylate, α,β-unsaturated C₃-C₆ carboxylic acids, α,β-unsaturated C₄-C₈ dicarboxylic acids, or anhydrides thereof, such as acrylic acid, methacrylic acid, crotonic acid, fumaric acid, maleic acid, maleic anhydride, itaconic acid, and itaconic anhydride, and also the alkali metal salts or ammonium salts of the stated monomers, especially their sodium salts.

Furthermore, esters of monoethylenically unsaturated C₃-C₆ monocarboxylic acids with polyether monools, more particularly with C₁-C₂₀ alkylpoly-C₂-C₄ alkylene glycols, especially with C₁-C₂₀ alkylpolyethylene glycols, the alkylpolyalkylene glycol radical typically having a molecular weight in the range from 200 to 5000 g/mol (numerical average), more particularly the aforementioned esters of acrylic acid and also the aforementioned esters of methacrylic acid are suitable. Furthermore, N-vinylpyrrolidone, phosphate esters of polyethylene glycol mono(meth)acrylate and its water-soluble salts where polyethylene glycol vary from 1-22 repeating units can be used.

Since the alkyl acrylate is a hydrophobic group whereas the sulfonic acid groups bearing ethylenically unsaturated monomer is a hydrophilic group the block copolymer is an amphiphilic substance.

The resulting block-copolymer is optionally of the formula (III):

X-[A]ₐ-[B]_{b}-Z (III), wherein
[A] is polymer block composed of alkyl acrylate, for example n-butylacrylate, and
a is an integer which indicates the number of monomers units in the polymer block [A], a being 10 to 80, for example 10 to 40,
[B] is a homopolymer block or a copolymer block composed of an ethylenically unsaturated monomer with sulfonic acid groups, for example sodium styrene sulfonic acid, and optional comonomers and
b is an integer which indicates the number of monomers units in the polymer block [B], b being 10 to 80, with the proviso that the molar ratio of polymer block [A] to polymer block [B] is 1:1 to 8:1, X is selected from the group consisting of —CH₂-phenyl, —CHCH₃-phenyl, —C(CH₃)₂-phenyl, —C(C₅-C₆-cycloalkyl)₂-CN, —C(CH₃)₂CN, —CH₂CH═CH₂, —CH₃CH—CH═CH₂, —(C₁-C₄alkyl)CR⁷—C(O)-phenyl, —(C₁-C₄)alkyl-CR⁷—C(O)—(C₁-C₄)alkoxy, —(C₁-C₄)alkyl-CR⁷—C(O)—(C₁-C₄)alkyl, —(C₁-C₄)alkyl-CR⁷—C(O)—N-di(C₁-C₄)alkyl, —(C₁-C₄)alkyl-CR⁷—C(O)—NH(C₁-C₄)alkyl, and —(C₁-C₄)alkyl-CR⁷—C(O)—NH₂, wherein
R⁷ is hydrogen or (C₁-C₄)alkyl and
Z is the terminal group of the block-copolymer, defined below.

The block-copolymer of the present invention is prepared by controlled free radical polymerization of at least 80 wt. % based on the weight of the monomers of the [A] block of alkyl acrylate, preferably n-butyl acrylate, which builds the first block and monomers comprising at least a sulfonic acid groups bearing ethylenically unsaturated monomers which builds the second block ([B] block).

The first block comprises at least 80 wt. % units of alkyl acrylate. This means that this first block is composed to an extent of at least 80 wt. %, more particularly at least 90 wt. %, especially at least 95 wt. %, or at least 99 wt. %, based on [A], respectively based on the total amount of the constituent monomers M of the polymer block [A], or entirely, of alkyl acrylate.

Suitable alkyl acrylates are esters of monoethylenically acrylic acid with C₄-C₂₀-alkanols, examples being n-butyl acrylate, 2-butyl acrylate, isobutyl acrylate, tert-butyl acrylate, n-hexyl acrylate, 2-ethylhexyl acrylate, 3-propylheptyl acrylate, decyl acrylate, lauryl acrylate and stearyl acrylate. Preferred is n-butylacrylate.

As additional monomers of the first block it is possible to use for example styrene, C₁-C₄ alkyl substituted styrene, hydroxyalkyl esters of the α,β-unsaturated C₃-C₆ carboxylic acids, for example 2-hydroxyethyl acrylate, 3-hydropxypropyl acrylate, 4-hydroxybutyl acrylate, hydroxyethyl methacrylate, hydroxypropyl methacrylate, polyethylene glycol mono(meth)acrylate where poly-ethylene glycol vary from 1-22 repeating units or mixtures thereof. If these additional monomers are present, they are present in an amount up to 20 wt. %, preferably up to 10 wt. %, especially up to 5 wt. %.

The second block comprises units of the ethylenically unsaturated monomer with sulfonic acid groups. This means that this second block is composed to for example an extent of at least 20 wt. %, more particularly at least 50 wt. %, especially at least 80 wt. %, or at least 90 wt. %, based on [13], respectively based on the total amount of the constituent monomers M of the polymer block [13], or entirely, of monoethylenically unsaturated monomers with sulfonic acid groups.

Suitable ethylenically unsaturated monomers with sulfonic acid groups are for example vinylsulfonic acid, 4-styrene sulfonic acid, 2-acrylamido-2-methylpropane sulfonic acid, sulfopropyl acrylate and sulfopropyl methacrylate. The ethylenically unsaturated monomer with sulfonic acid groups can be used as monomers in the form of the free acid as well as in their partially or completely neutralized form. For example, sodium hydroxide, potash or ammonia is used as a neutralizing agent. For example, styrene sulfonic acid and its alkali or ammonium salts may be used, especially sodium styrene sulfonate.

As additional monomers of the second block it is possible to use the amides and the hydroxy-alkyl esters of the α,β-unsaturated C₃-C₆ carboxylic acids, for example acrylamide, methacrylamide, 2-hydroxyethyl acrylate, 2-hydroxyethyl methacrylate, 2-hydroxypropyl (meth)acrylate or 1,4-butanediol monoacrylate, α,β-unsaturated C₃-C₆ carboxylic acids, α,β-unsaturated C₄-C₈ di-carboxylic acids, or anhydrides thereof, such as acrylic acid, methacrylic acid, crotonic acid, fumaric acid, maleic acid, maleic anhydride, itaconic acid, and itaconic anhydride, and also the alkali metal salts or ammonium salts of the stated monomers, especially their sodium salts.

Furthermore, esters of monoethylenically unsaturated C₃-C₆ monocarboxylic acids with polyether monools, more particularly with C₁-C₂₀ alkylpoly-C₂-C₄ alkylene glycols, especially with C₁-C₂₀ alkylpolyethylene glycols, the alkylpolyalkylene glycol radical typically having a molecular weight in the range from 200 to 5000 g/mol (numerical average), more particularly the aforementioned esters of acrylic acid and also the aforementioned esters of methacrylic acid are suitable.

Furthermore, N-vinylpyrrolidone, phosphate esters of polyethylene glycol mono(meth)acrylate and its water-soluble salts where polyethylene glycol vary from 1-22 repeating units can be used.

Since the alkyl acrylate is a hydrophobic group whereas the sulfonic acid groups bearing ethylenically unsaturated monomer is a hydrophilic group the block-copolymer is an amphiphilic substance.

The block-copolymer of the invention may, for example, have a terminal group of the formula Z in which,

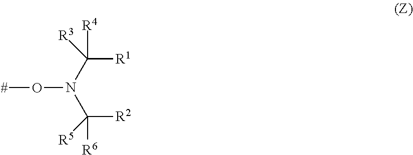

# denotes the attachment to a C atom of the polymer block,
R¹ and R² independently of one another are C₁-C₂₀ alkyl which optionally carries substituent selected from C₁-C₄ alkoxy, C₁-C₄ alkoxy-C₁-C₄ alkoxy and PO₃R^{z}₂, and R^{z} is C₁-C₄ alkyl, or are phenyl or are C₇-C₁₈ aralkyl or R¹ and R² together are linear C₂-C₁₀ alkylene or linear C₂-C₁₀ alkenylene in which optionally one or two CH₂ groups may have been independently of another replaced by O, C═O, C═NOH, CH—OCOCH₃ or NR^{x}, where linear C₂-C₁₀ alkylene and linear C₂-C₁₀ alkenylene are unsubstituted or have 1, 2, 3, 4 or 5 substituents from the group C₁-C₄ alkyl, C₁-C₄ alkoxy, C₁-C₄ alkoxy-C₁-C₄ alkoxy, COOH, and CONH₂, and Rx is C₁-C₄ alkyl or C₁-C₄ alkoxy;
R³ is C₁-C₄ alkyl or H,
R⁴, R⁵, and R⁶ independently of one another are C₁-C₄ alkyl, and more particularly methyl or ethyl.

In formula Z optionally R¹ and R² together are linear C₂-C₁₀ alkylene, in which, optionally, one or two CH₂ groups may have been replaced by O, C═O and/or NR^{x}, and where linear C₂-C₁₀ alkylene is unsubstituted or has 1, 2, 3, or 4 substituents from the group of C₁-C₄ alkyl, C₁-C₄ alkoxy, C₁-C₄ alkoxy-C₁-C₄ alkoxy, COOH, and CONH₂, and Rx is C₁-C₄ alkyl or C₁-C₄ alkoxy.

In formula Z more particularly R¹ and R² together are linear C₂-C₄ alkylene and especially are 1,3-propanediyl, in which optionally one or two CH₂ groups may have been replaced by O, C(═O), or NR^{x}, where linear C₂-C₄ alkylene or 1,3-propanediyl is unsubstituted or has 1, 2, 3, or 4 substituents from the group of C₁-C₄ alkyl and C₁-C₄ alkoxy, and Rx is C₁-C₄ alkyl, especially methyl.

In an embodiment of the presently claimed invention, the stable free nitroxyl radical is selected from the group consisting of radicals with the formula Za, Zb, Zc, Zd, Ze, Zf, Zg, and Zh

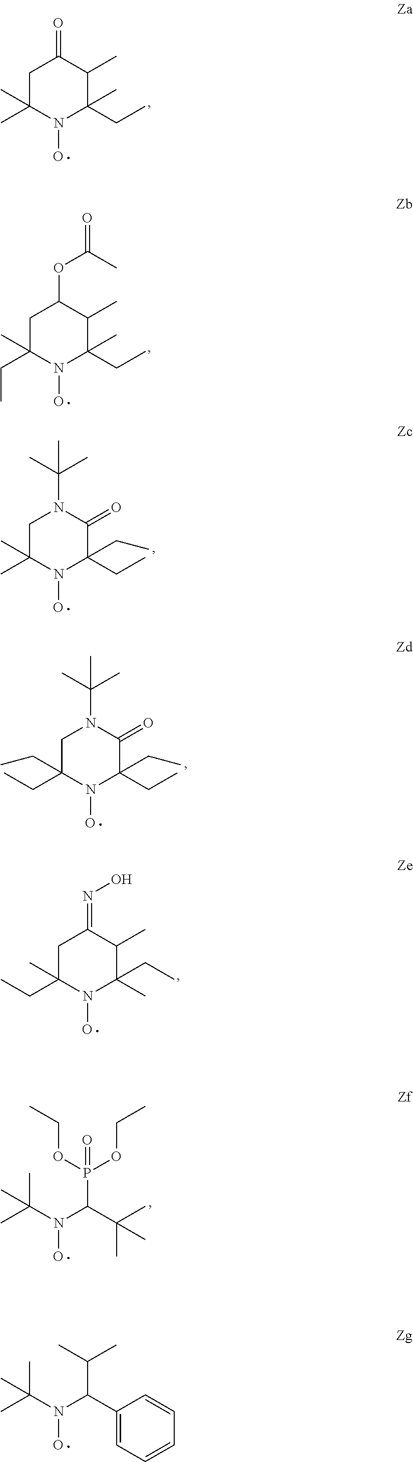

In an additional embodiment, the at least one stable free nitroxyl radical is of the formula Ze or Zh:

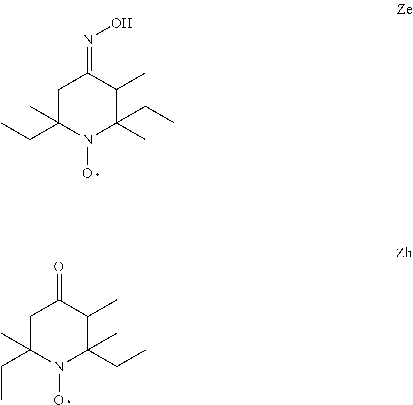

The block-copolymers of the invention may have a number-average molecular weight Mₙ in the range from 1,500 to 200,000 g/mol, more particularly 2,000 to 100,000 g/mol. The weight-average molecular weight M_{w} of the block-copolymers of the invention is situated typically in the range from 2,500 to 30,000 g/mol and more particularly in the range from 3,000 to 10,000 g/mol. The polydispersity, i.e., the ratio M_{w}/Mₙ, is situated typically in the range from 1 to 2 and more particularly in the range from 1.2 to 1.6.

The block-copolymer may have ≤80 especially ≤60 and ≥5, especially ≤40 and ≥10 average repeating units in Block [A], optionally entirely of the alkyl acrylate. Examples are block-copolymers with 15 to 60 average repeating units of the alkyl acrylate, which consist of more than 90% by mol of n-butylacrylate. Optionally they are block-copolymers with 15 to 40 average repeating units of the alkyl acrylate, which consist of more than 90% by mol of n-butylacrylate.

Block-copolymers may be used wherein the second block consists of ≤80 especially ≤70 and ≥5, especially ≥10 average monomer units in total. These monomer units are composed to an extent of at least 20 wt. %, more particularly at least 50 wt. %, especially at least 80 wt. %, or at least 90 wt. %, based on the total amount of the constituent monomers M of the second polymer block, or entirely, of monoethylenically unsaturated monomers with sulfonic acid groups.

The molar ratio of the monomers of polymer block [A] to the monomer of polymer block [B] may be 1:1 to 8:1, for example 1:1 to 6:1, especially 1:1 to 2.5:1. This equals the ratio of the number of the units. The block-copolymer optionally has a first block of n-butyl acrylate units and a second block of styrene sulfonic acid and/or its salts units and the number of units of the first block (block [A]) and to the number of units of the second block (block [B]) is in the ratio of 1:1 to 8:1, for example 1:1 to 2.5:1.

One method for providing the block-copolymer of the present invention is that of controlled radical polymerization by the NMP method (nitroxide-mediated polymerization). Suitable nitroxylethers and nitroxyl radicals are principally known from U.S. Pat. No. 4,581,429 or EP-A-621 878. Particularly useful are the open chain compounds described in WO 98/13392 (Akzo), WO 99/03894 (Ciba) and WO 00/07981 (Ciba), the piperidine derivatives described in WO 99/67298 (Ciba) and GB 2335190 (Ciba) or the heterocyclic compounds described in GB 2342649 (Ciba) and WO 96/24620 (Atochem). Further suitable nitroxylethers and nitroxyl radicals are described in WO 02/4805 (Ciba) and in WO 02/100831 (Ciba). Each of these references is incorporated herein by reference in their entirety.

The block-copolymer additive according to the invention is present in the roofing composition in an amount of 0.05 to 20 parts based on the total weight of the latex, or from 0.01 to 6% by weight based on the weight of the roofing composition.

One or more surfactants can be included in the aqueous dispersions to improve certain properties of the dispersions, including particle stability. For example, sodium laureth sulfate and alkylbenzene sulfonic acid or sulfonate surfactants could be used. Examples of commercially available surfactants include Calfoam® ES-303, a sodium laureth sulfate, and Calfax® DB-45, a sodium dodecyl diphenyl oxide disulfonate, both available from Pilot Chemical Company (Cincinnati, OH). In general, the amount of surfactants employed can be from 0.01 to 5%, based on the total amount of the monomers to be polymerized.

Small amounts (e.g., from 0.01 to 2% by weight based on the total monomer weight) of molecular weight regulators, such as a mercaptan, can optionally be used. Such substances are preferably added to the polymerization zone in a mixture with the monomers to be polymerized and are considered part of the total amount of unsaturated monomers used in the copolymers.

The first stage can have a Tg value of less than −20° C. as measured by differential scanning calorimetry (DSC) by measuring the midpoint temperature using ASTM D 3418-08. For example, the Tg of the first stage can be from −50° C. to −23° C., −40° C. to −25° C., or −33° C. to −26° C. In some examples, the Tg of the first stage is from −36° C. to −23° C. The second stage can have a Tg value of greater than −15° C. For example, the Tg of the second stage can be from −12° C. to 25° C., −9° C. to 5° C., or −5° C. to 0° C. In some examples, the Tg of the first stage is from −12° C. to 0° C.

In some embodiments, the latex made by a two-stage emulsion polymerization can be used to form the coating composition. The coating composition can further include at least one filler such as a pigment or extender. The term “pigment” as used herein includes compounds that provide color or opacity to the coating composition. Examples of suitable pigments include metal oxides, such as titanium dioxide, zinc oxide, iron oxide, or combinations thereof. The at least one pigment can be selected from the group consisting of TiO₂ (in both anastase and rutile forms), clay (aluminum silicate), CaCO₃ (in both ground and precipitated forms), aluminum oxide, alumina trihydrate, silicon dioxide, magnesium oxide, talc (magnesium silicate), barytes (barium sulfate), zinc oxide, zinc sulfite, sodium oxide, potassium oxide and mixtures thereof. Examples of commercially titanium dioxide pigments are KRONOS® 2101, KRONOS® 2310, available from Kronos WorldWide, Inc., TI-PURE® R-900, available from DuPont, or TIONA® AT1 commercially available from Millenium Inorganic Chemicals. Titanium dioxide is also available in concentrated dispersion form. An example of a titanium dioxide dispersion is KRONOS® 4311, also available from Kronos WorldWide, Inc. Suitable pigment blends of metal oxides are sold under the marks Minex® (oxides of silicon, aluminum, sodium and potassium commercially available from Unimin Specialty Minerals), Celite® (aluminum oxide and silicon dioxide commercially available from Celite Company), and Atomite® (commercially available from Imerys Performance Minerals). Exemplary fillers also include clays such as attapulgite clays and kaolin clays including those sold under the Attagel® and Ansilex® marks (commercially available from BASF Corporation). Additional fillers include nepheline syenite, (25% nepheline, 55% sodium feldspar, and 20% potassium feldspar), feldspar (an aluminosilicate), diatomaceous earth, calcined diatomaceous earth, talc (hydrated magnesium silicate), aluminosilicates, silica (silicon dioxide), alumina (aluminum oxide), mica (hydrous aluminum potassium silicate), pyrophyllite (aluminum silicate hydroxide), perlite, baryte (barium sulfate), Wollastonite (calcium metasilicate), and combinations thereof. More preferably, the at least one filler includes TiO₂, CaCO₃, and/or a clay.

Generally, the mean particle sizes of the filler ranges from about 0.01 to about 50 microns. For example, the TiO₂ particles used in the aqueous coating composition typically have a mean particle size of from about 0.15 to about 0.40 microns. The filler can be added to the aqueous coating composition as a powder or in slurry form. The filler is preferably present in the aqueous coating composition in an amount from about 5 to about 50 percent by weight, more preferably from about 10 to about 40 percent by weight (i.e. the weight percentage of the filler based on the total weight of the coating composition).

Examples of suitable pigment dispersing agents are polyacid dispersants and hydrophobic copolymer dispersants. Polyacid dispersants are typically polycarboxylic acids, such as polyacrylic acid or polymethacrylic acid, which are partially or completely in the form of their ammonium, alkali metal, alkaline earth metal, ammonium, or lower alkyl quaternary ammonium salts. Hydrophobic copolymer dispersants include copolymers of acrylic acid, methacrylic acid, or maleic acid with hydrophobic monomers. In certain embodiments, the composition includes a polyacrylic acid-type dispersing agent, such as Pigment Disperser N, commercially available from BASF SE.

Examples of suitable thickeners include hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, and combinations thereof. HEUR polymers are linear reaction products of diisocyanates with polyethylene oxide end-capped with hydrophobic hydrocarbon groups. HASE polymers are homopolymers of (meth)acrylic acid, or copolymers of (meth)acrylic acid, (meth)acrylate esters, or maleic acid modified with hydrophobic vinyl monomers. HMHECs include hydroxyethyl cellulose modified with hydrophobic alkyl chains. Hydrophobically modified polyacrylamides include copolymers of acrylamide with acrylamide modified with hydrophobic alkyl chains (N-alkyl acrylamide). In certain embodiments, the coating composition includes a hydrophobically modified hydroxyethyl cellulose thickener.

Defoamers serve to minimize frothing during mixing and/or application of the coating composition. Suitable defoamers include organic defoamers such as mineral oils, silicone oils, and silica-based defoamers. Exemplary silicone oils include polysiloxanes, polydimethylsiloxanes, polyether modified polysiloxanes, and combinations thereof. Exemplary defoamers include BYK®-035, available from BYK USA Inc., the TEGO® series of defoamers, available from Evonik Industries, the DREWPLUS® series of defoamers, available from Ashland Inc., and FOAMASTER® NXZ, available from BASF Corporation.

Suitable surfactants include nonionic surfactants and anionic surfactants. Examples of nonionic surfactants are alkylphenoxy polyethoxyethanols having alkyl groups of about 7 to about 18 carbon atoms, and having from about 6 to about 60 oxyethylene units; ethylene oxide derivatives of long chain carboxylic acids; analogous ethylene oxide condensates of long chain alcohols, and combinations thereof. Exemplary anionic surfactants include ammonium, alkali metal, alkaline earth metal, and lower alkyl quaternary ammonium salts of sulfosuccinates, higher fatty alcohol sulfates, aryl sulfonates, alkyl sulfonates, alkylaryl sulfonates, and combinations thereof. In certain embodiments, the composition comprises a nonionic alkylpolyethylene glycol surfactant, such as LUTENSOL® TDA 8 or LUTENSOL® AT-18, commercially available from BASF SE. In certain embodiments, the composition comprises an anionic alkyl ether sulfate surfactant, such as DISPONIL® FES 77, commercially available from BASF SE. In certain embodiments, the composition comprises an anionic diphenyl oxide disulfonate surfactant, such as CALFAX® DB-45, commercially available from Pilot Chemical.

Optionally, the coating compositions can further include quick setting additives. Exemplary quick setting additives suitable for use in the coating compositions described herein includes polyamines (i.e., polymers formed from either an amine-group containing monomer or an imine monomer as polymerized units such as aminoalkyl vinyl ether or sulfides; acrylamide or acrylic esters, such as dimethylaminoethyl(meth)acrylate; N-(meth)acryloxyalkyl-oxazolidines such as poly(oxazolidinylethyl methacrylate), N-(meth)acryloxyalkyltetrahydro-1,3-oxazines, and monomers that readily generate amines by hydrolysis). Suitable polyamines can include, for example, poly(oxazolidinylethyl methacrylate), poly(vinylamine), or polyalkyleneimine (e.g., polyethyleneimine). In some embodiments, the quick setting additive is a derivatized polyamine such as an alkoxylated polyalkyleneimine (e.g., ethoxylated polyethyleneimine). Suitable derivatized polyamines are described in U.S. Application Ser. No. 61/714,497, filed Oct. 16, 2012, which is incorporated by reference herein in its entirety.

Other suitable additives that can optionally be incorporated into the composition include coalescing agents (coalescents), pH modifying agents, biocides, co-solvents and plasticizers, crosslinking agents, dispersing agents, rheology modifiers, wetting and spreading agents, leveling agents, conductivity additives, adhesion promoters, anti-blocking agents, anti-cratering agents and anti-crawling agents, anti-freezing agents, corrosion inhibitors, anti-static agents, flame retardants and intumescent additives, dyes, optical brighteners and fluorescent additives, UV absorbers and light stabilizers, chelating agents, cleanability additives, flatting agents, flocculants, humectants, insecticides, lubricants, odorants, oils, waxes and slip aids, soil repellants, stain resisting agents, and combinations thereof.

Suitable coalescents, which aid in film formation during drying, include ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, 2,2,4-trimethyl-1,3-pentanediol monoisobutyrate, and combinations thereof.

Examples of suitable pH modifying agents include bases such as sodium hydroxide, potassium hydroxide, amino alcohols, monoethanolamine (MEA), diethanolamine (DEA), 2-(2-aminoethoxy)ethanol, diisopropanolamine (DIPA), 1-amino-2-propanol (AMP), ammonia, and combinations thereof.

Suitable biocides can be incorporated to inhibit the growth of bacteria and other microbes in the coating composition during storage. Exemplary biocides include 2-[(hydroxymethyl)amino]ethanol, 2-[(hydroxymethyl) amino]2-methyl-1-propanol, o-phenylphenol, sodium salt, 1,2-benzisothiazolin-3-one, 2-methyl-4-isothiazolin-3-one (MIT), 5-chloro2-methyl and -4-isothiazolin-3-one (CIT), 2-octyl-4-isothiazolin-3-one (OIT), 4,5-dichloro-2-n-octyl-3-isothiazolone, as well as acceptable salts and combinations thereof. Suitable biocides also include biocides that inhibit the growth of mold, mildew, and spores thereof in the coating. Examples of mildewcides include 2-(thiocyanomethylthio)benzothiazole, 3-iodo-2-propynyl butyl carbamate, 2,4,5,6-tetrachloroisophthalonitrile, 2-(4-thiazolyl)benzimidazole, 2-N-octyl4-isothiazolin-3-one, diiodomethyl p-tolyl sulfone, as well as acceptable salts and combinations thereof. In certain embodiments, the coating composition contains 1,2-benzisothiazolin-3-one or a salt thereof. Biocides of this type include PROXEL® BD20, commercially available from Arch Chemicals, Inc. The biocide can alternatively be applied as a film to the coating and a commercially available film-forming biocide is Zinc Omadine® commercially available from Arch Chemicals, Inc.

Exemplary co-solvents and humectants include ethylene glycol, propylene glycol, diethylene glycol, and combinations thereof.

Exemplary crosslinking agents include dihydrazides (e.g., dihydrazides of adipic acid, succinic acid, oxalic acid, glutamic acid, or sebastic acid). The dihydrazides can be used, for example, to crosslink diacetone acrylamide or other crosslinkable monomers.

An elastomeric roof coating composition can be produced by combining the components as described herein into a homogeneous mixture. In some embodiments, the method can include preparing a latex composition of the polymer. A latex composition can be prepared by polymerizing monomers, such as styrene monomers, acrylate and methacrylate monomers, butadiene monomers, and optionally additional monomers in an aqueous emulsion polymerization reaction at a suitable temperature. In some embodiments, the polymerization can be carried out at 40° C. or greater, 50° C. or greater, or 60° C. or greater. In some embodiments, the polymerization temperature can be from 40° C. to 100° C., 40° C. to 95° C., or 50° C. to 90° C. In some embodiments, the block-copolymer additive can be added directly into the elastomeric roof coating formulation.

The resulting coating compositions can have a viscosity of from 12,000 to 140,000 cps at 25° C. For example, the coating compositions can have a viscosity of from 15,000 to 80,000 cps, 20,000 to 75,000 cps, 25,000 to 70,000 cps, 30,000 to 65,000 cps, 35,000 to 60,000 cps, or 40,000 to 55,000 cps at 25° C.

The volume solids percentage of the coating composition can be greater than 50%. For example, the volume solids percentage of the coating composition can be greater than 55%, greater than 60%, greater than 65%, greater than 70%, or greater than 75%.

Optionally, the weight solids percentage of the coating composition can be greater than 60%. For example, the weight solids percentage can be greater than 65%, greater than 70%, greater than 75%, or greater than 80%.

In some embodiments, the coating composition can include the following components (based on total weight of the coating composition): water 6.8-17.2% by weight, propylene glycol 0.5-2.5% by weight, pigment dispersing agent 0.4-0.85% by weight, copolymer dispersion (at 55-65% by weight copolymer) 37.8-41.3% by weight, plasticizer 0-1.0% by weight, defoamer 0.3-1.4% by weight, non-ionic surfactant 0-0.1% by weight, thickener 0.1-0.4% by weight, titanium dioxide 3.0-11.2% by weight, zinc oxide 0-3.4% by weight, calcium carbonate 27.7-33.7% by weight, alumina trihydrate, talc or kaolin 0-18.3% by weight, biocide 0.1-0.3% by weight, and ammonia 0.1-0.3% by weight.

The coating composition can be applied to a substrate (e.g., as a film) and allowed to dry to form a dried coating. Generally, coatings are formed by applying a coating composition described herein to a surface, and allowing the coating to dry to form a dried coating. In some embodiments, the surface can be a substantially horizontal surface such as a roof surface. In some embodiments, the surface can be a substantially vertical surface such as a wall. Optionally, the coating composition can be applied to floors to provide moisture control to provide crack-bridging properties. Also, the coating composition, when applied as a film and dried, can pass the mandrel bend test set forth in ASTM D 6083-05 at −26° C.

The coating composition can be applied to a surface by any suitable coating technique, including spraying, rolling, brushing, or spreading. Coating compositions can be applied in a single coat, or in multiple sequential coats (e.g., in two coats or in three coats) as required for a particular application. Generally, the coating composition is allowed to dry under ambient conditions. However, in certain embodiments, the coating composition can be dried, for example, by heating and/or by circulating air over the coating.

The coating can be co-applied with a setting accelerator to decrease the setting time of the coating on a surface. Suitable setting accelerators include compounds, such as acids, which consume the volatile base and decrease coating setting time. For example, the setting accelerator can be a dilute acid, such as acetic acid or citric acid. Setting accelerators can be applied to a surface prior to coating application, applied simultaneously with the coating composition, or applied to the coating after it has been applied to a surface but prior to drying.

The coating thickness can vary depending upon the application of the coating. For example, the coating can have a dry thickness of at least 10 mils (e.g., at least 15 mils, at least 20 mils, at least 25 mils, at least 30 mils, or at least 40 mils). In some instances, the coating has a dry thickness of less than 100 mils (e.g., less than 90 mils, less than 80 mils, less than 75 mils, less than 60 mils, less than 50 mils, less than 40 mils, less than 35 mils, or less than 30 mils). In some embodiments, the coating has a dry thickness of between 10 mils and 100 mils. In certain embodiments, the coating has a dry thickness of between 10 mils and 40 mils.

The examples below are intended to further illustrate certain aspects of the methods and compositions described herein and are not intended to limit the scope of the claims.

### EXAMPLES

The following examples are put forth so as to provide those of ordinary skill in the art with a complete disclosure and description of how the compositions and/or methods claimed herein are made and evaluated and are intended to be purely exemplary and are not intended to limit the scope of the disclosure. Unless indicated otherwise, parts are parts by weight, temperature is in ° C. or is at ambient temperature, and pressure is at or near atmospheric.

Preparation of the Block Copolymer

The production process of the amphiphilic block copolymers described below with A as initiator was carried out with 2,6-diethyl-2,3,6-trimethyl-1-(1-phenylethoxy)-4-piperidinone (hereinafter referred to as alkoxyamine A) as polymerization initiator.

### Example 1.1 A-Block 1.1: Synthesis of a Linear Polybutyl Acrylate (BA)

Under nitrogen atmosphere 225 g of alkoxyamine A (0.71 mol) was dissolved in 4088 g n-butyl acrylate (31.9 mol). The mixture was degassed three times. Following which, it was heated to 115° C. and stirred at that temperature until desired monomer conversion was reached. Conversion was determined by solid content measurement according to ISO 3251. As soon as the targeted monomer conversion of n-butyl acrylate was obtained vacuum was applied and residual monomer was removed by vacuum distillation at 100° C. and 15 mbar. The solid content was >98%.

TABLE 1
A-Block preparation

| | | Alkoxyamine | nBA | | Average |
|---|---|---|---|---|---|
| | A- | A [g]/ | [g]/ | Conversion | repeating |
| Example | Block | [mol] | [mol] | [%] | units |
| 1.1 | 1.1 | 225/0.71 | 4088/31.9 | 44 | 20 |

nBA = n-butyl acrylate
alkoxyamine A = 2,6-diethyl-2,3,6-trimethyl-1-(1-phenylethoxy)-4-piperidinone

### Example 2.1: Synthesis of a Linear Block Copolymer Poly(n-BA-b-NaSS)

Under nitrogen atmosphere 267 g sodium styrene sulfonate were dissolved in 3551 g N,N-dimethyl formamide (7% by weight NaSS) and 350 g of A-Block 1.1 was added The mixture was heated to 115° C. and stirred at that temperature until desired monomer conversion was reached. Conversion was determined by NMR measurement. As soon as full monomer conversion was obtained vacuum was applied and solvent removed by vacuum distillation at 155° C. and 5 mbar. The solid content was >99%

TABLE 2
Monomer compositions of the B-Block preparation

| | | | | | Average | Average |
|---|---|---|---|---|---|---|
| Example | | A- | | | repeating | repeating |
| No. = AB | | Block | A-Block | NaSS | units | units |
| Block No. | A-Block | [g] | [mol] | [g]/[mol] | A-Block | B-Block |
| 2.1 | 1.1 | 350 | 0.117 | 267/1.29 | 20 | 10 |

Preparation of Aqueous Polymer Dispersions

291 g water, 0.51 g of a 40% aqueous solution of ethylenediamine tetraacetic acid (EDTA) and 9.3 g polystyrene seed latex were placed into a reaction vessel and the mixture was heated to 85° C. From an initiator feed of 56.4 g water and 2.97 g sodium persulfate, 9% was removed and added to the reaction mixture. Subsequently, the following three separate feeds were added with constant feed rate to the reactor over 4 hours:
(a) initiator feed 54.05 g
(b) monomer emulsion mixture comprising 331 g water, 14.85 g methacrylic acid, 17.8 g acetoacetoxyethyl methacrylate, 167.3 g methyl methacrylate, 790 g butyl acrylate and 3.9 g of ammonium hydroxide of 19% activity
(c) 81.7 g of block-copolymer having a solids content of 20%

During the entire duration of the feeds, the temperature was held at 85° C. After the feed stage, the monomer emulsion tank was flushed with 19.8 g water and the temperature was reduced to 75° C. The dispersion was post stripped by adding the following two mixtures as two separate feeds over the course of 0.75 hours:
(a) 5.7 g of a 70% tert-butyl hydroperoxide solution and 23.0 g water
(b) 4.0 g sodium metabisulfite and 24.7 g water.

The latex was then cooled, and optional post-additions were added. The polymer dispersion has a total solids content of 53.9% based on the weight of the aqueous dispersion, a pH of 7.6 and a viscosity of 2870 cps.

Preparation of Elastomeric Roof Coatings

An elastomeric roof coating was formulated by adding to 73.5 gram de-ionized water the flowing ingredients: 7.8 g Tamol, 4.2 g propylene glycol, 1.8 g Foamaster NXZ, 0.7 g potassium tri-polyphosphate, 192.5 g Huber SB432 aluminum trihydrate, 35 g Ti-Pure R-60 titanium dioxide, and 21 g Kadox 915 zinc oxide. To this pigment the following was added under agitation: 401 g of the latex of the disclosure, 13.4 g water, 1.4 g Foamaster NXZ, 4.5 g Texanol 4.5, 1.4 g ammonia and a blend of 2.8 g Natrosol MXR with 6.3 g propylene glycol. The ingredients were mixed to form a homogenous formulation. The formulation solids were in the 63-65 wt. % range, the viscosity in the range of 85 to 120 KU at 25° C., and the pH was in the range of 8.5-9.5.

1.-30. (canceled)

31. An elastomeric roof coating composition comprising a polymer composition comprising
a) latex comprising a first and second stage polymer composition, and
b) a block-copolymer in an amount of from 0.003% to 3% by weight based on the weight of the elastomeric roof coating composition, and
c) water
wherein the block copolymer has a first block comprising of alkyl acrylate and a second block comprising units of an ethylenically unsaturated monomer with sulfonic acid groups.

32. The composition of claim 31, wherein the latex has a carbon polymer backbone formed by polymerized ethylenically unsaturated monomers comprising acrylic monomers.

33. The composition of claim 31, wherein the latex has a carbon polymer backbone formed by polymerized ethylenically unsaturated monomers comprising styrene and acrylic monomers.

34. The composition of claim 31, wherein the block-copolymer is present in an amount of from about 0.01% to 1% by weight based on the weight of the elastomeric roof coating composition.

35. The composition of claim 31, wherein the first stage of the latex comprises one or more (meth)acrylate monomers, one or more acid monomers, and styrene.

36. The composition of claim 31, wherein the first stage of the latex comprises one or more (meth)acrylate monomers and one or more acid monomers.

37. The composition of claim 35, wherein the first stage of the latex comprises one or more vinyl silanes.

38. The composition of claim 36, wherein the first stage of the latex comprises one or more vinyl silanes

39. The composition of claim 35 comprising a block copolymer.

40. The composition of claim 35 comprising acrylonitrile monomer

41. An elastomeric roof coating composition comprising a polymer composition comprising
a) a latex polymer
b) a block-copolymer in an amount of from 0.003% to 3% by weight based on the weight of the elastomeric roof coating composition.
c) water.

42. The composition of claim 41, wherein the latex polymer is made by a single stage polymerization.

43. The composition of claim 42 wherein the single stage polymerization comprises a block copolymer.

44. The elastomeric roof composition of claim 41, wherein the elastomeric roof coatings possess greater than 100% elongation after exposure to artificial weathering for 1000 hours

45. The elastomeric roof composition of claim 41, wherein the elastomeric roof coatings possess greater than 80% of their initial elongation after exposure to artificial weathering for 1000 hours

46. The elastomeric roof composition of claim 31, wherein the block-copolymer is a block-copolymer of formula (III):
X-[A]a-[B]_{b}-Z (III), wherein
[A] is polymer block composed of an alkyl acrylate, and
a is an integer which indicates the number of monomers units in the polymer block [A], a being 10 to 80,
[B] is a homopolymer block or a copolymer block composed of an ethylenically unsaturated monomer with sulfonic acid groups, and optional comonomers and
b is an integer which indicates the number of monomers units in the polymer block [B], b being 10 to 80, with the proviso that the molar ratio of polymer block [A] to polymer block [B] is 1:1 to 8:1,
X is selected from the group consisting of —CH₂-phenyl, —CHCH₃-phenyl, —C(CH₃)₂-phenyl, —C(C₅-C₆-cycloalkyl)₂-CN, —C(CH₃)₂CN, —CH₂CH═CH₂, —CH₃CH—CH═CH₂, —(C₁-C₄alkyl)CR⁷—C(O)-phenyl, —(C₁-C₄)alkyl-CR⁷—C(O)—(C₁-C₄)alkoxy, —(C₁-C₄)alkyl-CR⁷—C(O)—(C₁-C₄)alkyl, —(C₁-C₄)alkyl-CR⁷—C(O)—N-di(C₁-C₄)alkyl, —(C₁-C₄)alkyl-CR⁷—C(O)—NH(C₁-C₄)alkyl, and —(C₁-C₄)alkyl-CR⁷—C(O)—NH₂, wherein
R⁷ is hydrogen or (C₁-C₄)alkyl and
Z is a terminal group of formula Z 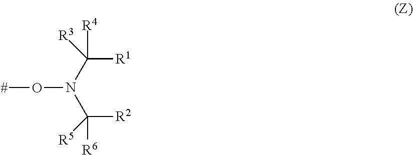
in which:
# denotes attachment to a C atom of B,
R¹ and R² independently of one another are C₁-C₂₀ alkyl which optionally carries substituent selected from C₁-C₄ alkoxy, C₁-C₄ alkoxy-C₁-C₄ alkoxy and PO₃R^{z}₂, and R^{z} is C₁-C₄ alkyl, or are phenyl or are C₇-C₁₈ aralkyl or R¹ and R² together are linear C₂-C₁₀ alkylene or linear C₂-C₁₀ alkenylene in which optionally one or two CH₂ groups may have been independently of another replaced by O, C═O, C═NOH, CH—OCOCH₃ or NR^{x}, where linear C₂-C₁₀ alkylene and linear C₂-C₁₀ alkenylene are unsubstituted or have 1, 2, 3, 4 or 5 substituents from the group C₁-C₄ alkyl, C₁-C₄ alkoxy, C₁-C₄ alkoxy-C₁-C₄ alkoxy, COOH, and CONH₂, and Rx is C₁-C₄ alkyl or C₁-C₄ alkoxy;
R³ is C₁-C₄ alkyl or H,
R⁴, R⁵, and R⁶ independently of one another are C₁-C₄ alkyl.

47. The asphalt composition according to claim 44, wherein:
[A] is polymer block composed of n-butylacrylate, and
[B] is a homopolymer block or a copolymer block composed of sodium styrene sulfonic acid, and optional comonomers.

48. The asphalt composition according to claim 44, wherein:
a is 10 to 40.

49. A method for providing a flexible roofing, which comprises applying an aqueous coating composition as claimed in claim 31 to a flat roof having an inclination of not more than 15 degrees.
